(19) United States
(12) Patent Application Publication
(10) Pub. No.: US 2009/0244675 A1
(43) Pub. Date: Oct. 1, 2009

(54) ELECTRODE AND MIRROR DRIVING APPARATUS

(75) Inventors: Kenji RIKIMARU, Fukuoka (JP); Yuji Ishii, Fukuoka (JP); Kazuyuki Mori, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/411,342

(22) Filed: Mar. 25, 2009

(30) Foreign Application Priority Data
Mar. 26, 2008 (JP) 2008-080953
Nov. 28, 2008 (JP) 2008-305657

(51) Int. Cl. G02B 26/08

(52) U.S. Cl. 359/221.2

(57) ABSTRACT

An electrode includes a fixed electrode and a movable electrode. The electrode drives a mirror disposed on the side of the movable electrode by generating electrostatic force between the fixed electrode and the movable electrode when voltage is applied. The fixed electrode and the movable electrode are formed so that a distance between the fixed electrode and the movable electrode increases as an overlapping area between the fixed electrode and the movable electrode increases.

### CROSS-REFERENCE TO RELATED APPLICATION

This application is based upon and claims the benefit of priority of the prior Japanese Patent Application No. 2008-080953, filed on Mar. 26, 2008; and Japanese Patent Application No. 2008-305657, filed on Nov. 28, 2008, the entire contents of which are incorporated herein by reference.

### FIELD

The embodiments discussed herein are directed to an electrode and a mirror driving apparatus.

### BACKGROUND

In recent years, optical networks that allow high speed communication become widely used, and optical signals are transmitted by utilizing a relay device such as an optical switch. The optical switch has a micro electro mechanical systems (MEMS) mirror, and adjusts an optical path of an optical signal and attenuation of light by using the MEMS mirror (see Japanese Laid-open Patent Publication No. 2004-361920 and Japanese Laid-open Patent Publication No. 2007-65594, for example).

Here, a mirror driving apparatus that drives the MEMS mirror will be explained. FIG. 37 depicts a configuration of a conventional mirror driving apparatus. As depicted in FIG. 37, a mirror driving apparatus 10 includes a MEMS mirror 11, a collimator lens (condensing lens) 12, and an optical fiber 13.

FIG. 38 is a view for explaining an operation of the mirror driving apparatus of FIG. 37. As illustrated in FIG. 37, the mirror driving apparatus 10 manipulates the position where incident light abuts on the collimator lens 12 by changing an angle of the MEMS mirror 11 to thereby adjust attenuation of light.

Specifically, since the collimator lens 12 has such a characteristic that it has larger optical fiber transmittance near its center, and smaller optical fiber transmittance near its end, the mirror driving apparatus 10 shifts the position of light beam (incident light) from the center toward the end of the collimator lens 12 for increasing attenuation of light. On the other hand, for decreasing the attenuation of light, the mirror driving apparatus 10 shifts the position of the light beam from the end toward the center of the collimator lens 12 to adjust attenuation of light.

Here, relationship (tolerance curve) between attenuation of light (light attenuation) and control voltage for controlling the MEMS mirror will be explained. FIG. 39 depicts a conventional tolerance curve. As depicted in FIG. 39, variation in attenuation with respect to voltage is small near the maximum point of the tolerance curve (light power maximum point), however, attenuation with respect to the same voltage (same angular variation) increases as attenuation increases. This tolerance curve can be approximated by a quartic function of voltage.

However, the conventional technique has such a problem that when attenuation of light is attempted to be increased, variation in attenuation with respect to variation in control voltage increases, as depicted in FIG. 39, so that the control resolution is rough and fine control of attenuation is disabled.

As an attenuation characteristic of light, a characteristic of mirror angle variation with respect to control voltage of the MEMS mirror is proportional to square of voltage, and light attenuation attenuates with respect to the mirror angle according to the Gaussian's definition. Relationship between mirror angle and voltage can be represented by the following formula:

Mirror angle [deg]≅α×V² (α is a value determined by characteristics of the MEMS mirror driving apparatus)

Since attenuation of light changes with a quartic function of voltage, the larger the attenuation, the more the influence by voltage control variation becomes, and variation in light is more likely to occur. Relationship between attenuation and voltage can be represented by the following formula:

Attenuation [dB]≅α×V⁴+β×V²+γ (α, β, and γ are values determined by characteristics of the MEMS mirror driving apparatus)

When the voltage is applied to the MEMS mirror to change only one axis (e.g., X-axis), attenuation of light changes as depicted in FIGS. 40 and 41. FIG. 40 depicts variation in attenuation achieved by controlling the X-axis, whereas FIG. 41 is a graph representing the variation in attenuation achieved by controlling the X-axis as depicted in FIG. 40.

In order to control the attenuation on the order of 0 dB to 0.5 dB, the mirror driving apparatus assigns a control code to each coordinate of the X-axis such that the control code is assigned to substantially every 0.5 dB as depicted in FIG. 40, and controls the voltage according to the assigned control code. Here, the control code and the voltage applied to the MEMS mirror according to the control code are determined in advance.

FIG. 42 depicts a relation between an ideal value and the attenuation achieved by the control based on the control code; FIG. 43 is a graph representing the relation depicted in FIG. 42. As depicted in FIGS. 42 and 43, as the attenuation increases, the variation in attenuation corresponding to the changed control code increases. Therefore, an error between the ideal value and the actual attenuation achieved through voltage control increases to cause distortion.

### SUMMARY

According to one aspect of the present invention, an electrode includes a fixed electrode, and a movable electrode, the electrode drives a mirror disposed on the side of the movable electrode by generating electrostatic force between the fixed electrode and the movable electrode when voltage is applied, and the fixed electrode and the movable electrode are formed so that a distance between the fixed electrode and the movable electrode increases as an overlapping area between the fixed electrode and the movable electrode increases.

According to another aspect of the present invention, a mirror driving apparatus includes a mirror that has a first axis and a second axis, and whose angle is controlled through application of voltage on at least one of the first axis and the second axis, a rate of variation in attenuation with respect to a rotation angle of the mirror around the first axis and a rate of variation in attenuation with respect to the rotation angle of the mirror around the second axis being different from each other, and an attenuation adjusting unit that adjusts attenuation of light by applying voltage on at least one of the first axis and the second axis to control an angle of the mirror and to adjust a position where light is applied.

According to still another aspect of an embodiment, a mirror driving apparatus includes an electrode including a fixed electrode and a movable electrode, the electrode being configured to drive a mirror disposed on the side of the movable electrode by generating electrostatic force between the fixed electrode and the movable electrode when voltage is applied on at least one of a first axis and a second axis, and a distance between the fixed electrode and the movable electrode widens as an area where the fixed electrode and the movable electrode overlap with each other increases, and an attenuation adjusting unit that adjusts attenuation of light by applying voltage on at least one of the first axis and the second axis, and the electrode is configured to change the attenuation by a different rate of variation when the voltage is applied on the first axis from when the voltage is applied on the second axis.

Additional objects and advantages of the invention will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is a view for explaining an operation of an electrostatic actuator;

FIG. 2 depicts a structure of a conventional MEMS actuator;

FIG. 3 is a view for explaining an operation of a MEMS actuator;

FIG. 4 depicts relationship between voltage and angle according to the conventional MEMS actuator;

FIG. 5 depicts relationship between control voltage and attenuation according to the conventional MEMS actuator;

FIG. 6 depicts relationship between control voltage and attenuation according to the conventional MEMS actuator, represented by specific numerical values;

FIG. 7 is a functional block diagram depicting a configuration of a control device according to a first embodiment;

FIG. 8 depicts one example of data structure of a management table according to the first embodiment;

FIG. 9 depicts relationship between control voltage and attenuation in the management table of FIG. 8;

FIG. 10 depicts a MEMS movable unit electrode according to the first embodiment;

FIG. 11 depicts relationship between voltage and angle according to a MEMS actuator according to the first embodiment;

FIG. 12 depicts a tolerance curve of the MEMS actuator according to the first embodiment and a conventional tolerance curve;

FIG. 13 is a view for explaining a feature of a mirror driving apparatus according to a second embodiment of the preset invention;

FIG. 14 depicts a configuration of the mirror driving apparatus according to the second embodiment;

FIG. 15 is a view for explaining a collimator lens;

FIG. 16 depicts a configuration of a control device according to the second embodiment;

FIG. 17 is a graph for explaining a first control method;

FIG. 18 depicts attenuation achieved by X-axis control and Y-axis control, respectively;

FIG. 19 is a graph representing variation in attenuation achieved by X-axis control and Y-axis control as depicted in FIG. 18;

FIG. 20 depicts attenuation achieved by X-axis and Y-axis control according to the first control method;

FIG. 21 is a graph representing relation of the attenuation achieved by X-axis and Y-axis control according to the first control method;

FIG. 22 depicts one example of data structure of a control table according to the first control method;

FIG. 23 depicts a relation between an ideal value and attenuation achieved by each control code according to the first control method;

FIG. 24 is a graph for explaining a second control method;

FIG. 25 depicts attenuation achieved by X-axis and Y-axis control according to the second control method;

FIG. 26 is a graph representing relation of the attenuation by X-axis and Y-axis control depicted in FIG. 25;

FIG. 27 depicts one example of data structure of a control table according to the second control method;

FIG. 28 depicts a relation between an ideal value and attenuation of each control code according to the second control method;

FIG. 29 is a graph for explaining a third control method;

FIG. 30 is a graph of variation of attenuation achieved by the third control method;

FIG. 31 is a graph representing relation of the attenuation by X-axis and Y-axis control depicted in FIG. 30;

FIG. 32 depicts one example of data structure of a control table according to the third control method;

FIG. 33 depicts a relation between an ideal value and attenuation achieved by each control code according to the third control method;

FIG. 34 is a flowchart of a process sequence of a mirror driving apparatus executing the first control method;

FIG. 35 is a flowchart of a process sequence of a mirror driving apparatus executing the second control method;

FIG. 36 is a flowchart of a process sequence of a mirror driving apparatus executing the third control method;

FIG. 37 depicts a configuration of a conventional mirror driving apparatus;

FIG. 38 is a view for explaining an operation of the mirror driving apparatus of FIG. 37;

FIG. 39 depicts a conventional tolerance curve;

FIG. 40 depicts variation in attenuation achieved by X-axis control;

FIG. 41 is a graph of the variation in attenuation achieved by X-axis control depicted in FIG. 40;

FIG. 42 depicts a relation between an ideal value and attenuation controlled by a control code; and

FIG. 43 is a graph representing relation between the ideal value and the attenuation depicted in FIG. 42.

### DESCRIPTION OF EMBODIMENTS

In the following, preferred embodiments of an electrode and a mirror driving apparatus according to the present invention will be specifically explained.

### First Embodiment

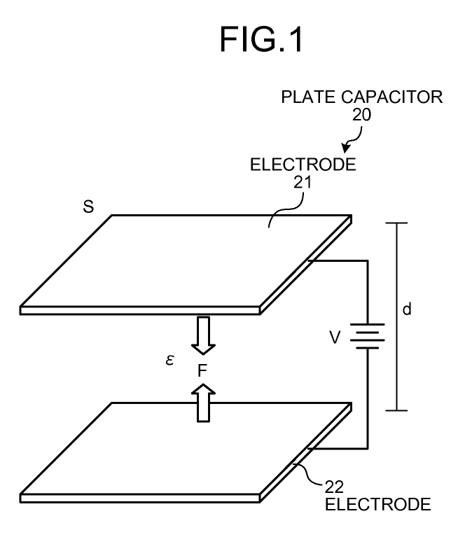

First, an operation of a general electrostatic actuator will be explained. FIG. 1 is a view for explaining an operation of an electrostatic actuator. A basic structure of an electrostatic actuator is a plate capacitor 20 and has such a simple structure that attracting force generated between two electrodes 21 and 22 when voltage is applied to the electrodes 21 and 22 is directly used.

When voltage “V” is applied between the electrodes 21 and 22, a force is generated by electrostatic force. Taking the generating electrostatic force as “F”, distance between polar plates as “d”, polar plate area as “S”, and dielectric constant as “ε”, F=1÷2×ε×S÷d²×V² is established.

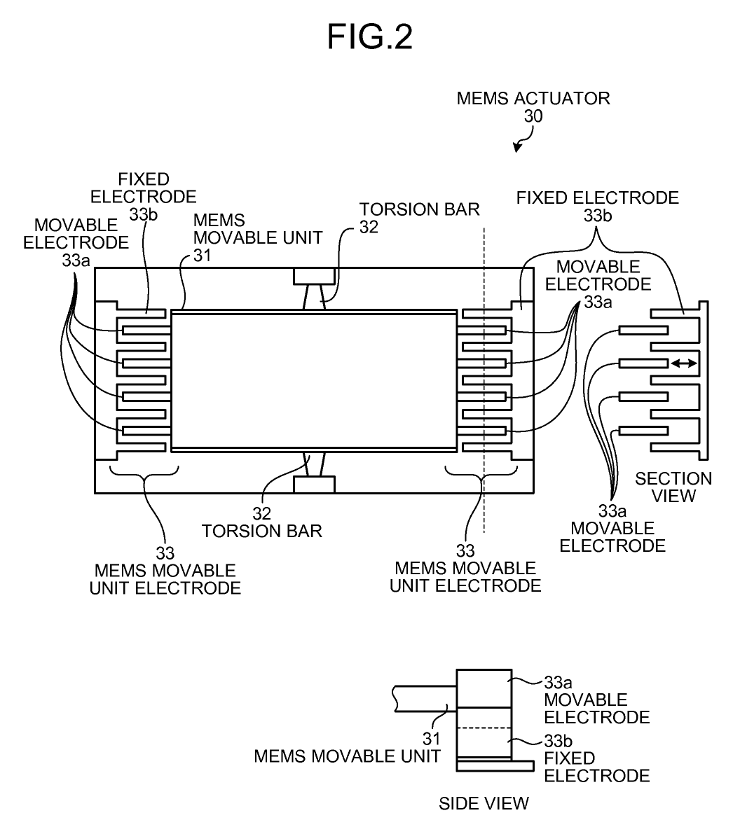

Next, a structure of a conventional micro electro mechanical systems (MEMS) actuator will be explained. FIG. 2 depicts a structure of a conventional MEMS actuator 30. As depicted in FIG. 2, the MEMS actuator 30 includes a MEMS movable unit 31 having a mirror, a torsion bar 32 that supports the MEMS movable unit 31, and a MEMS movable unit electrode 33. The MEMS movable unit electrode 33 includes a movable electrode 33a connected with the MEMS movable unit 31 and a fixed electrode 33b.

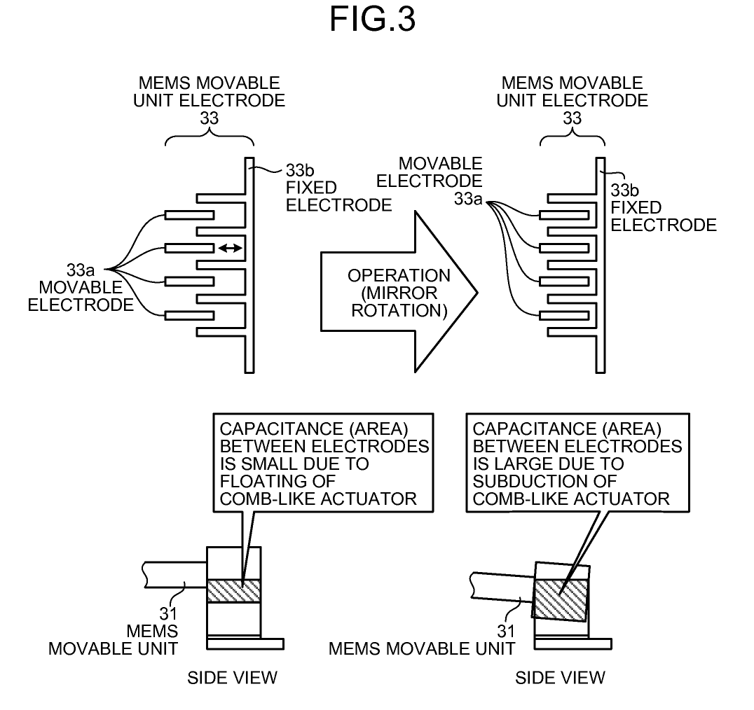

FIG. 3 is a view for explaining an operation of the MEMS actuator 30. By applying voltage on the MEMS movable unit electrode 33, electrostatic force generates between the movable electrode 33a and the fixed electrode 33b, and the fixed electrode 33b draws in the movable electrode 33a.

For example, when voltage is applied on the MEMS movable unit electrode 33 depicted on the left side of FIG. 3, the movable electrode 33a is drawn into the fixed electrode 33b, so that the condition as depicted on the right side of FIG. 3 is achieved. Comparing the left side and the right side of FIG. 3, an overlapping area between the movable electrode 33a and the fixed electrode 33b (or capacitance between the electrodes) is larger in the right side than in the left side.

Therefore, owing to the characteristic of an electrostatic actuator, although the MEMS movable unit 31 moves only a little even when large voltage is applied in the condition of the left side in FIG. 3 (the condition where the overlapping area is small), the MEMS movable unit 31 moves by application of only small voltage in the condition of the right side of FIG. 3 (the condition where the overlapping area is large).

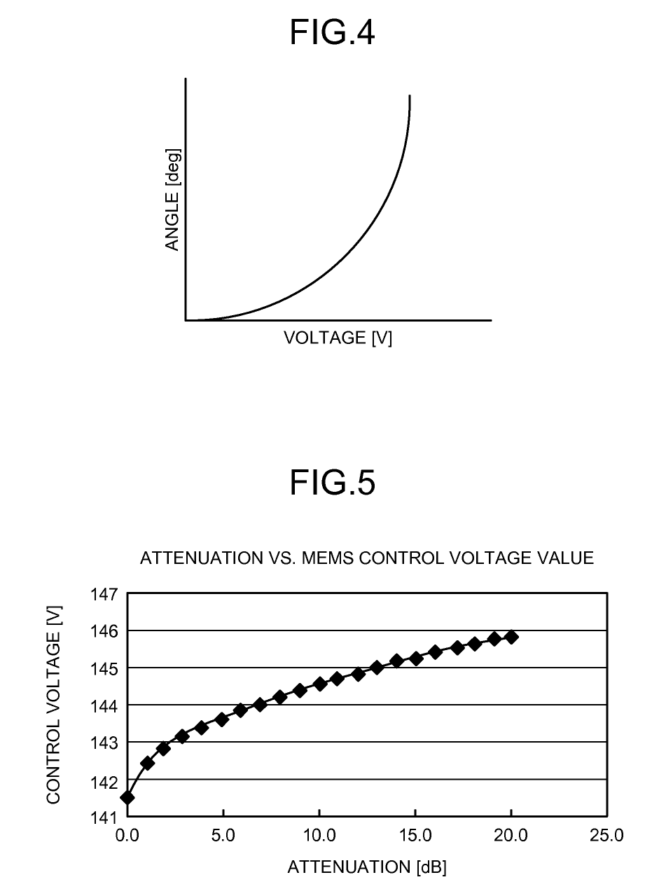

FIG. 4 depicts relationship between voltage and angle according to the conventional MEMS actuator 30. As depicted in FIG. 4, the rate of variation in angle with respect to voltage is small in a low-voltage region, however, the rate of variation in angle with respect to voltage is large in a high-voltage region (the relationship between voltage and angle exhibits a square-law characteristic).

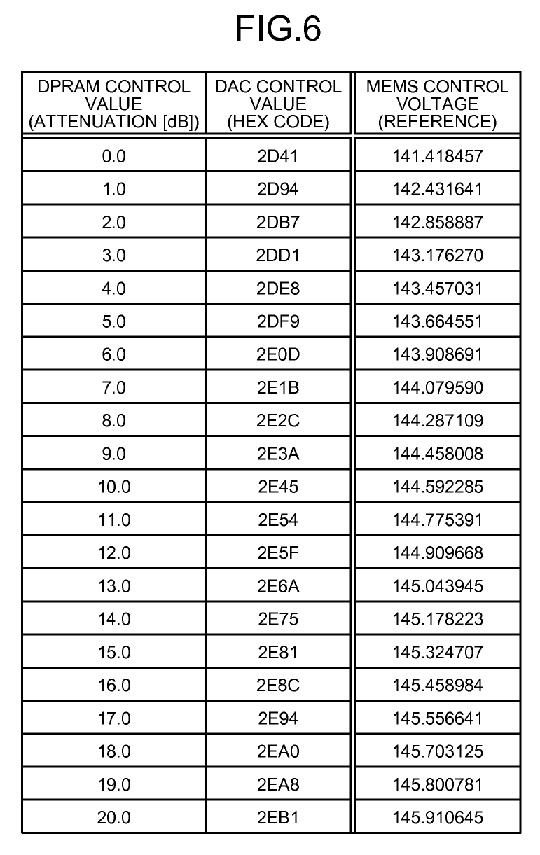

As illustrated in FIG. 4, in the conventional MEMS actuator 30, since the relationship between voltage and angle changes quadratically, variation in angle with respect to variation in voltage is large in the high-voltage region. When attenuation of light is attempted to be increased (when attenuation is attempted to be increased by increasing voltage), variation in attenuation with respect to variation in control voltage increases (see FIG. 5 and FIG. 6), and control resolution becomes rough. This leads to the problem that fine control of attenuation cannot be made. FIG. 5 depicts relationship between control voltage and attenuation according to a conventional MEMS actuator, and FIG. 6 depicts relationship between control voltage and attenuation according to the conventional MEMS actuator, represented by specific numerical values.

Next, a MEMS actuator according to a first embodiment of the present invention will be explained. In a MEMS actuator 100 according to the first embodiment, a fixed electrode and a movable electrode are formed so that a distance between the fixed electrode and the movable electrode increases as an overlapping area between the fixed electrode and the movable electrode increases. By forming the fixed electrode and the movable electrode in this manner, it is possible to keep electrostatic force substantially constant owing to characteristics of an electrostatic actuator, and to keep a rate of variation in attenuation with respect to voltage constant irrespective of a magnitude of applied voltage (relationship between control voltage and mirror angle has a linear characteristic). Therefore, it is possible to control attenuation accurately.

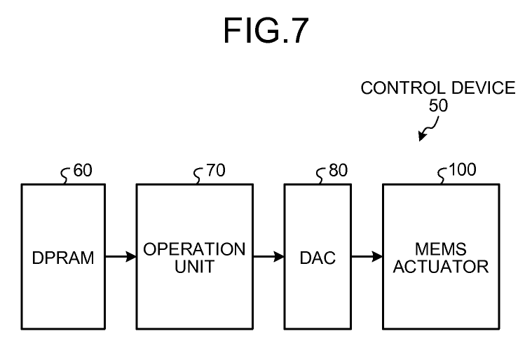

Next, a configuration of a control device that controls a MEMS actuator will be explained. FIG. 7 is a functional block diagram depicting a configuration of a control device according to the first embodiment. As depicted in FIG. 7, a control device 50 includes a data processing random access memory (DPRAM) 60, an operation unit 70, a digital analog converter (DAC) 80, and the MEMS actuator (MEMS mirror) 100.

Here, the DPRAM 60 is a unit that is connected with a higher device (not shown), and executes data communication with the higher device, and stores attenuation information output from the higher device. This attenuation information is attenuation to be adjusted by the control device 50.

The operation unit 70 is a unit that calculates control voltage for controlling the MEMS actuator 100 based on attenuation information stored in the DPRAM 60, and outputs information of control voltage which is a calculation result to the DAC 80.

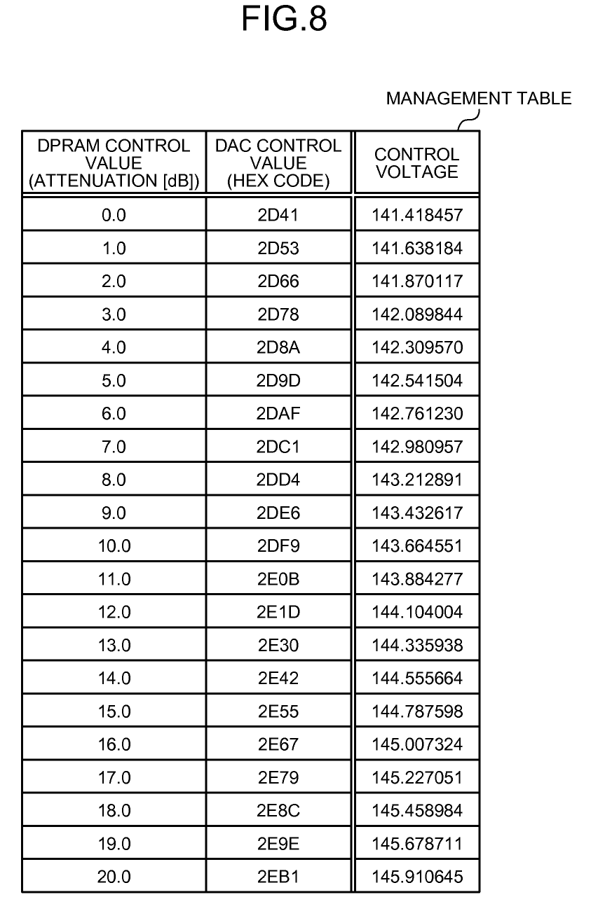

Specifically, the operation unit 70 has a management table, and calculates control voltage by comparing the management table with attenuation information. FIG. 8 is one example of data structure of a management table according to the first embodiment. As depicted in FIG. 8, the management table includes DPRAM control value (attenuation), DAC control value, and control voltage.

For example, the operation unit 70 acquires attenuation information of the DPRAM 60, and outputs DAC control value “2D53” (141.638184 V) to the DAC 80 when the attenuation is 1.0 [dB].

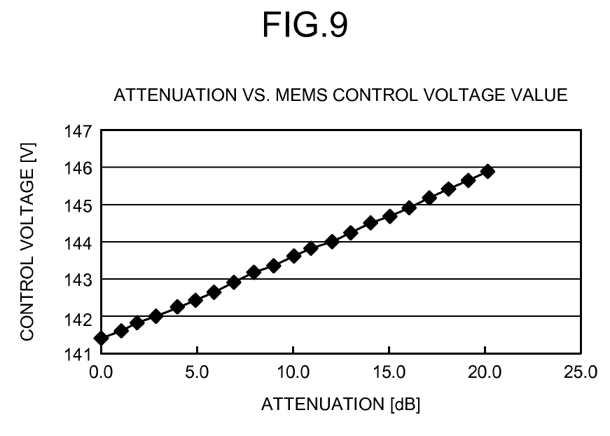

FIG. 9 is a graph representing relationship between control voltage and attenuation in the management table depicted in FIG. 8. Unlike the case of FIG. 5, the relationship between control voltage and attenuation is roughly linear in the control device 50 according to the first embodiment, so that it becomes possible to facilitate the control of attenuation by control voltage. The reason why the relationship between control voltage and attenuation is linear will be described later.

The DAC 80 is a unit that, when it acquires the information of control voltage (DAC control value) from the operation unit 70, applies control voltage on the MEMS actuator 100 based on acquired information of control voltage. The DAC 80 has a table in which DAC control value and control voltage are associated with each other. For example, the DAC 80 applies control voltage “141.638184 V” on the MEMS actuator 100 when it acquires DAC control value “2D53”.

The MEMS actuator 100 is a unit that adjusts attenuation. The mirror angle of the MEMS actuator 100 is controlled by application of control voltage, and an optical path of light applied to the collimator lens (not shown) through the MEMS actuator 100 is changed. The MEMS actuator 100 according to the first embodiment differs from the MEMS actuator 30 depicted in FIG. 2 in shape of MEMS movable unit electrode (the remaining configuration is similar).

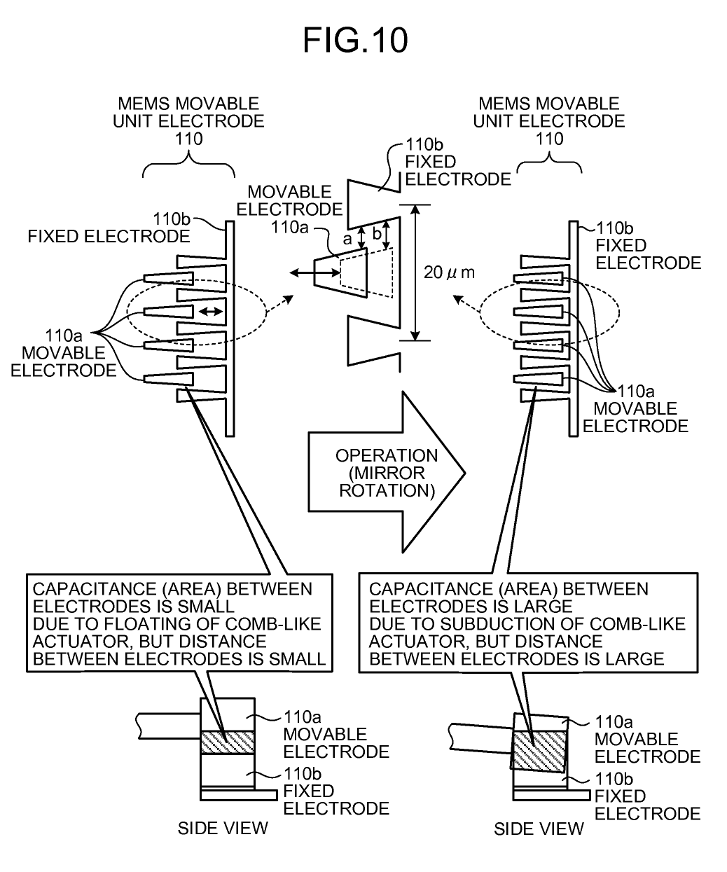

FIG. 10 depicts a MEMS movable unit electrode 110 according to the first embodiment. As illustrated in FIG. 10, the MEMS movable unit electrode 110 is formed so that a distance between a movable electrode 110a and a fixed electrode 110b increases as an overlapping area between the movable electrode 110a and the fixed electrode 110b increases by application of control voltage.

As depicted in the center of the upper stage of FIG. 10, taking a distance between the electrodes before the movable electrode 110a is drawn into the fixed electrode 110b as “a”, and a distance between the electrodes after the movable electrode 110a is drawn into the fixed electrode 110b as “b”, a<b is satisfied.

Therefore, even when the movable electrode 110a is drawn into the fixed electrode 110b (when the overlapping area between the movable electrode 110a and the fixed electrode 110b increases) by application of control voltage on the MEMS movable unit electrode 110, electrostatic force is kept constant and control voltage and mirror angle has a substantially proportional relationship because the distance between the movable electrode 110a and the fixed electrode 110b increases.

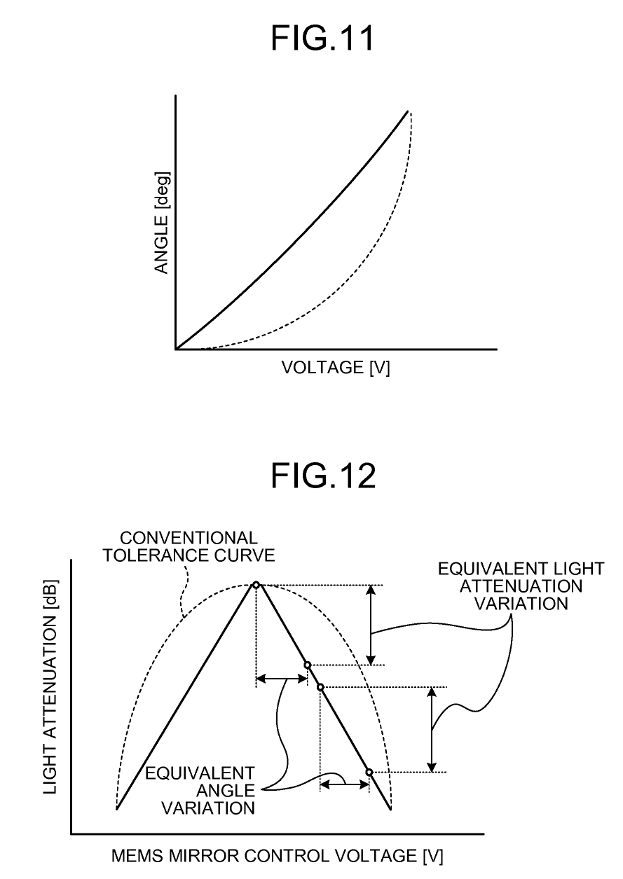

FIG. 11 depicts relationship between voltage and angle according to the MEMS actuator 100 according to the first embodiment. The dashed line in FIG. 11 indicates the relationship between voltage and angle according to the conventional MEMS actuator 30.

As illustrated in FIG. 11, in the MEMS actuator 100 according to the first embodiment, since electrostatic force is constant irrespective of the positional relationship between the movable electrode 110a and the fixed electrode 110b, it is possible to linearly approximate the relationship between voltage and angle.

FIG. 12 depicts a tolerance curve of the MEMS actuator 100 according to the first embodiment and a conventional tolerance curve. As depicted in FIG. 12, unlike the conventional tolerance curve in which the rate of variation in attenuation changes depending on the magnitude of voltage, the rate of variation in attenuation is constant irrespective of the magnitude of voltage in the tolerance curve according to the first embodiment. Therefore, attenuation control by voltage is facilitated and attenuation can be adjusted accurately.

As described above, in the MEMS actuator 100 according to the first embodiment, the fixed electrode and the movable electrode are formed so that a distance between the fixed electrode and the movable electrode increases as an overlapping area between the fixed electrode and the movable electrode increases. By forming the fixed electrode and the movable electrode in this manner, it is possible to keep electrostatic force substantially constant owing to characteristics of an electrostatic actuator, and to keep a rate of variation in attenuation with respect to voltage constant irrespective of a magnitude of applied voltage (in other words, relationship between control voltage and mirror angle has a linear characteristic). Therefore, it is possible to control attenuation accurately.

Further, since the light attenuation changes linearly by voltage by the MEMS actuator 100 according to the first embodiment, it becomes possible to conduct uniform control as dynamic characteristic. Further, it is possible to reduce the influence by control error (such as power unit noise or external noise).

### Second Embodiment

Next, a mirror driving apparatus according to a second embodiment will be explained. A mirror driving apparatus according to the second embodiment adjusts attenuation of light by forming a MEMS mirror of two axes (for example, X-axis and Y-axis) having different V/θ characteristics (rate of variation in voltage (attenuation) with respect to angle), and controlling an angle of the mirror by combination of the X-axis and the Y-axis.

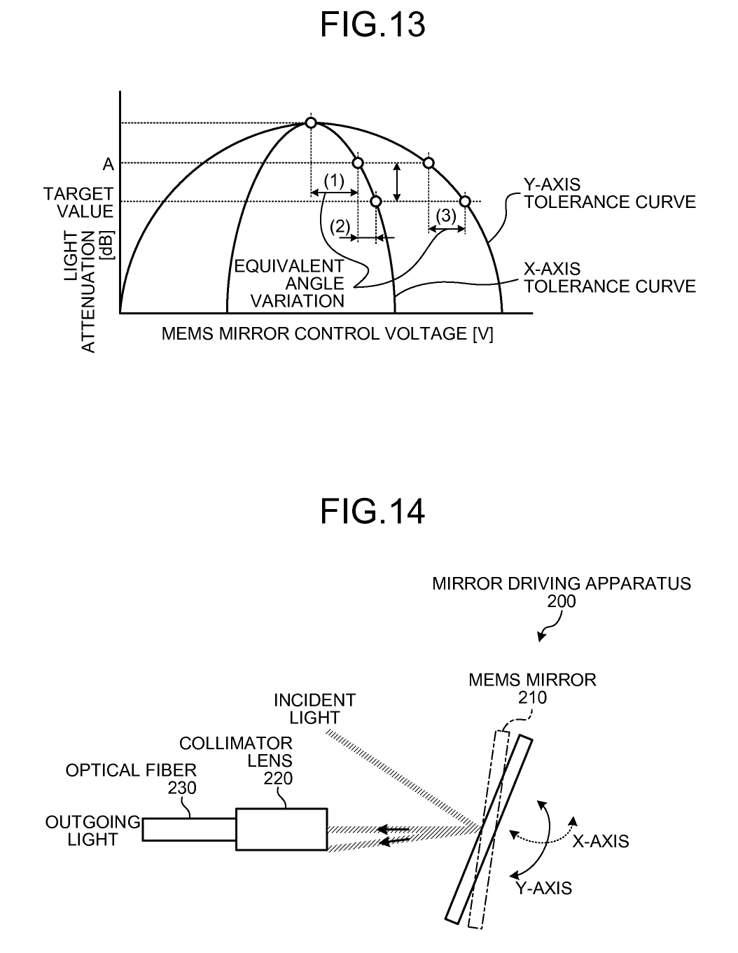

FIG. 13 is a graph for explaining a feature of the mirror driving apparatus according to the second embodiment. As illustrated in FIG. 13, since the X-axis and the Y-axis have different V/θ characteristics, the tolerance curve of the X-axis and the tolerance curve of the Y-axis also differ from each other.

The mirror driving apparatus according to the second embodiment controls a gentle part in the tolerance curve by a region where the V/θ characteristic is large, that is, (1) in FIG. 13, and a steep part in the tolerance curve, that is (2) in FIG. 13 by a region where the V/θ characteristic is large, that is (3) in FIG. 13. For example, when a target value as depicted in FIG. 13 is set, the mirror driving apparatus adjusts attenuation by applying voltage on the X-axis until attenuation reaches A, while adjusts attenuation from A to a target value by applying voltage on the Y-axis. Here, the V/θ characteristic is larger in the X-axis than in the Y-axis.

Since attenuation is adjusted by controlling the angle of MEMS mirror by combining the axes having different V/θ characteristics in this manner, it is possible to control the light attenuation characteristic by a more uniform voltage step.

Next, a configuration of a mirror driving apparatus 200 according to the second embodiment will be explained. FIG. 14 depicts a configuration of the mirror driving apparatus 200 according to the second embodiment. As depicted in FIG. 14, the mirror driving apparatus 200 includes a MEMS mirror (MEMS actuator) 210, a collimator lens (condensing lens) 220, and an optical fiber 230.

The MEMS mirror 210 is a mirror that has an X-axis and a Y-axis, and rotates based on one of the X-axis and the Y-axis or both, when voltage is applied on one of the X-axis and the Y-axis or both. The MEMS mirror 210 changes the position where the incident light abuts on the collimator lens 220 by control of its rotation, and thereby adjust attenuation of light. It is to be noted that the X-axis and the Y-axis are previously set to have different V/θ characteristics between the X-axis and the Y-axis.

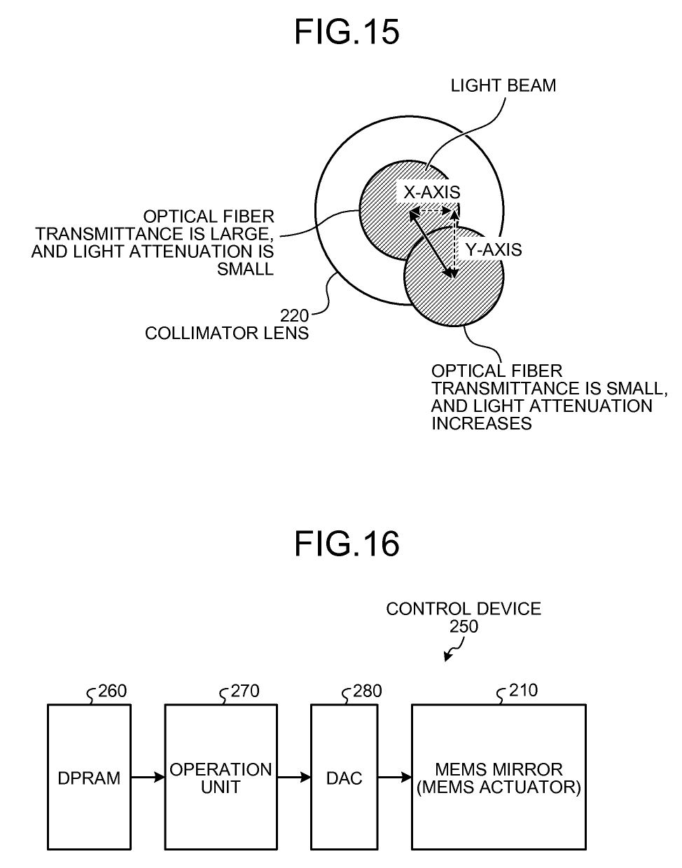

FIG. 15 is a view for explaining the collimator lens 220. As illustrated in FIG. 15, in the collimator lens 220, optical fiber transmittance is large near its center (light attenuation is small), and optical fiber transmittance is small near its end (light attenuation is large). That is, as the light beam moves from the center part toward the end of the collimator lens 220, attenuation of light increases.

For increasing the attenuation of light, the mirror driving apparatus 200 shifts the position of the light beam (incident light) toward the end from the center of the collimator lens 220. On the other hand, for decreasing the attenuation of light, the mirror driving apparatus 200 shifts the position of the light beam toward the center from the end of the collimator lens 220, to adjust attenuation of light.

Next, a control device that controls the MEMS mirror 210 will be explained. FIG. 16 depicts a configuration of a control device 250 according to the second embodiment. As depicted in FIG. 16, the control device 250 includes a DPRAM 260, an operation unit 270, a DAC 280 and the MEMS mirror 210.

Here, the DPRAM 260 is a unit that is connected with a higher device (not shown), and executes data communication with the higher device, and stores attenuation information output from the higher device. The attenuation information is attenuation to be adjusted by the control device 250.

The operation unit 270 is a unit that calculates control voltage for controlling the MEMS actuator 210 based on attenuation information stored in the DPRAM 260, and outputs information of control voltage which is an operation result to the DAC 280.

The DAC 280 is a unit that, when it acquires the information of control voltage from the operation unit 270, applies control voltage on one of the X-axis and the Y-axis or both of the MEMS mirror 210, based on acquired information of control voltage.

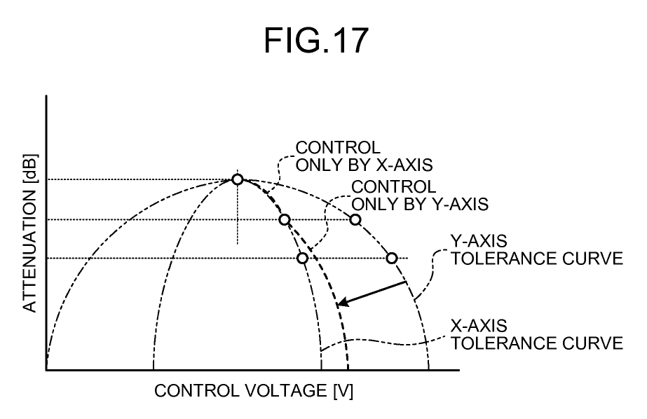

Here, three methods will be given as exemplary control methods of the control device 250 for the MEMS mirror 210. In the following, a first control method, a second control method, and a third control method are explained in this order. Firstly, the first control method is explained. FIG. 17 is a graph for explaining the first control method.

In the first control method of FIG. 17, the control device 250 applies voltage on the X-axis until a predetermined attenuation (for example, attenuation of a half of target value) is achieved. After achievement of the predetermined attenuation, voltage is applied on the Y-axis to adjust attenuation to a target value.

Here, when V/θ characteristic is larger in the X-axis than in the Y-axis, since adjustment from a predetermined attenuation to a target value is conducted by application of voltage on the Y-axis, variation in attenuation with respect to voltage is gentle and attenuation can be adjusted to a target value accurately.

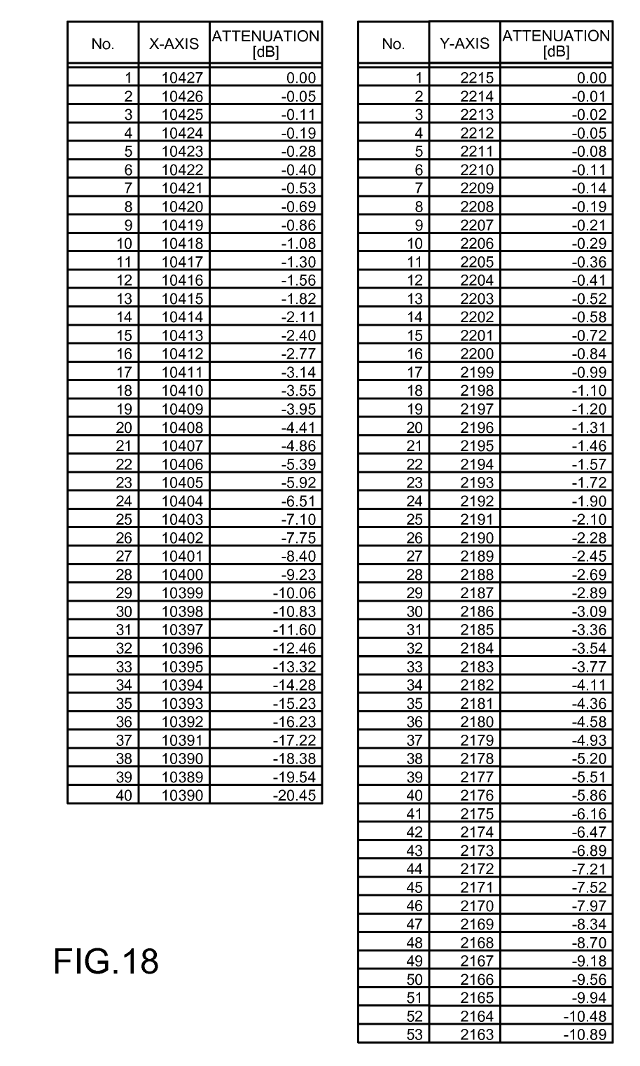

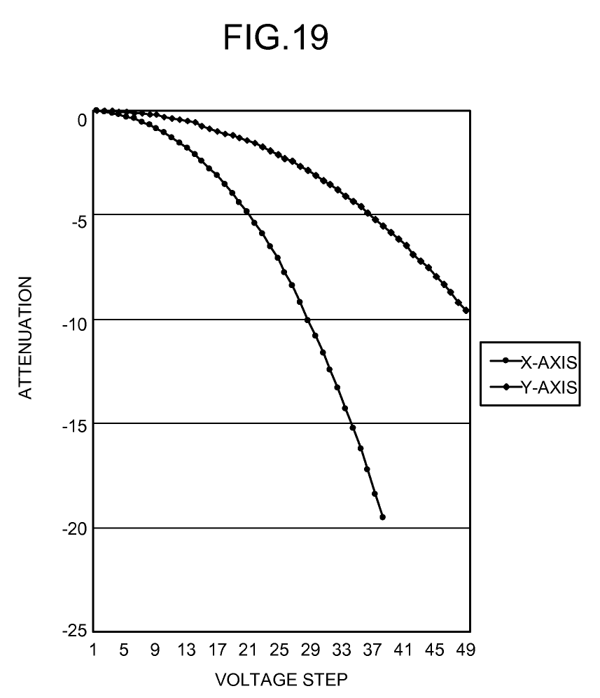

FIG. 18 depicts attenuation achieved by X-axis control and Y-axis control, respectively. Specifically, the left side of FIG. 18 represents variation in attenuation achieved by the X-axis control (coordinate change in X-axis); whereas the right side of FIG. 18 represents variation in attenuation achieved by the Y-axis control (coordinate change in Y-axis). Further, FIG. 19 is a graph representing the variation in attenuation by the X-axis control and the Y-axis control depicted in FIG. 18.

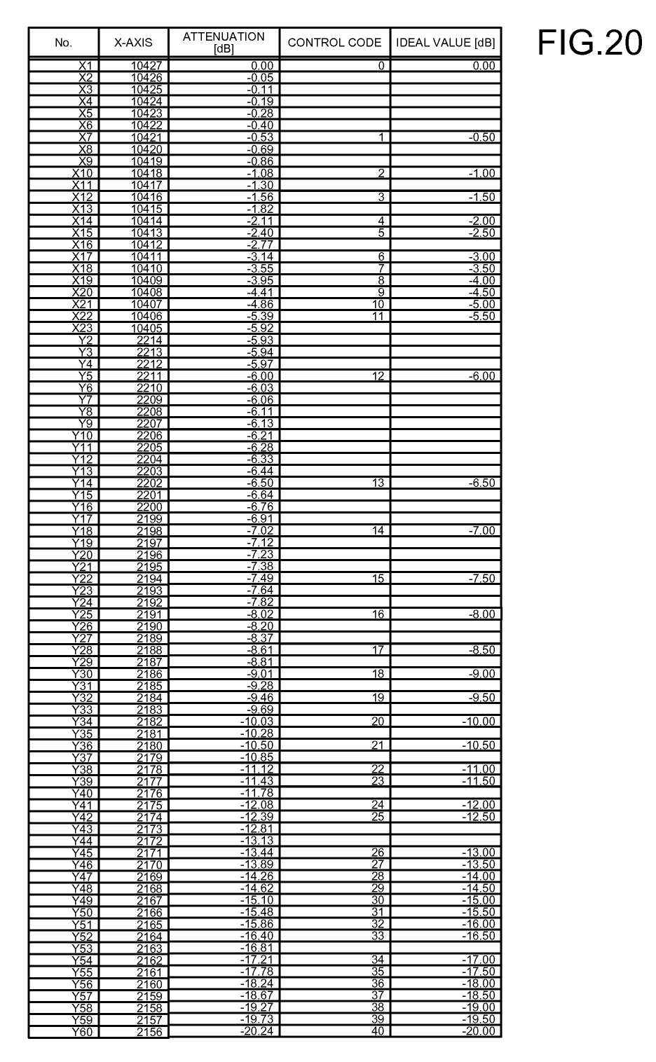

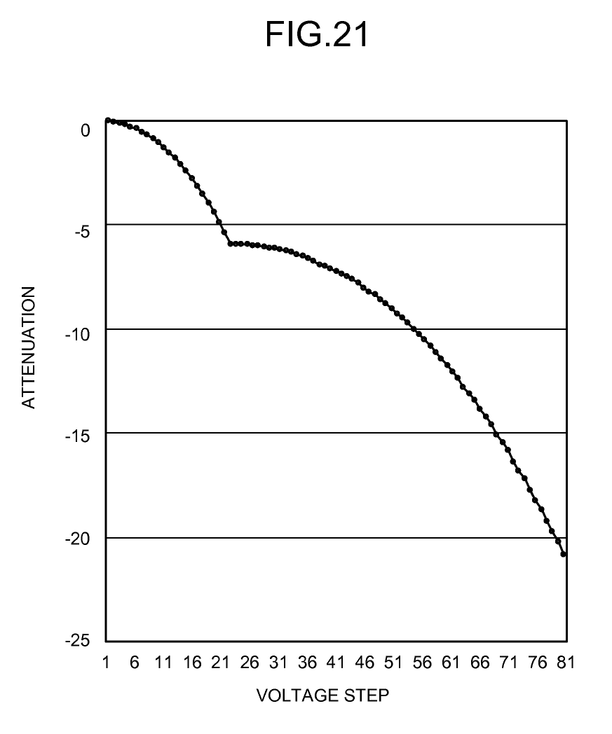

According to the first control method, firstly, the voltage is applied on the X-axis until the attenuation reaches a predetermined level. Thereafter, the voltage is applied on the Y-axis. For the simplicity of description, it is assumed that the voltage is applied firstly on the X-axis until the attenuation reaches “−5.92 dB”, and then applied secondly on the Y-axis. The variation in attenuation achieved in this case by the X-axis and Y-axis control are explained. FIG. 20 depicts attenuation achieved by the X-axis and Y-axis control according to the first control method, and FIG. 21 is a graph representing relation of the attenuation achieved by the X-axis and Y-axis control as depicted in FIG. 20.

When the control device 250 actually controls the attenuation (for example, when controlling the attenuation by every 0.5 dB), the control device 250 extracts approximate data of every 0.5 dB (−0.5 dB, −1.0 dB, −1.5 dB, . . . ) based on the data depicted in FIG. 20. The control device 250 formulates a control table by assigning a control code to each piece of the extracted approximate data.

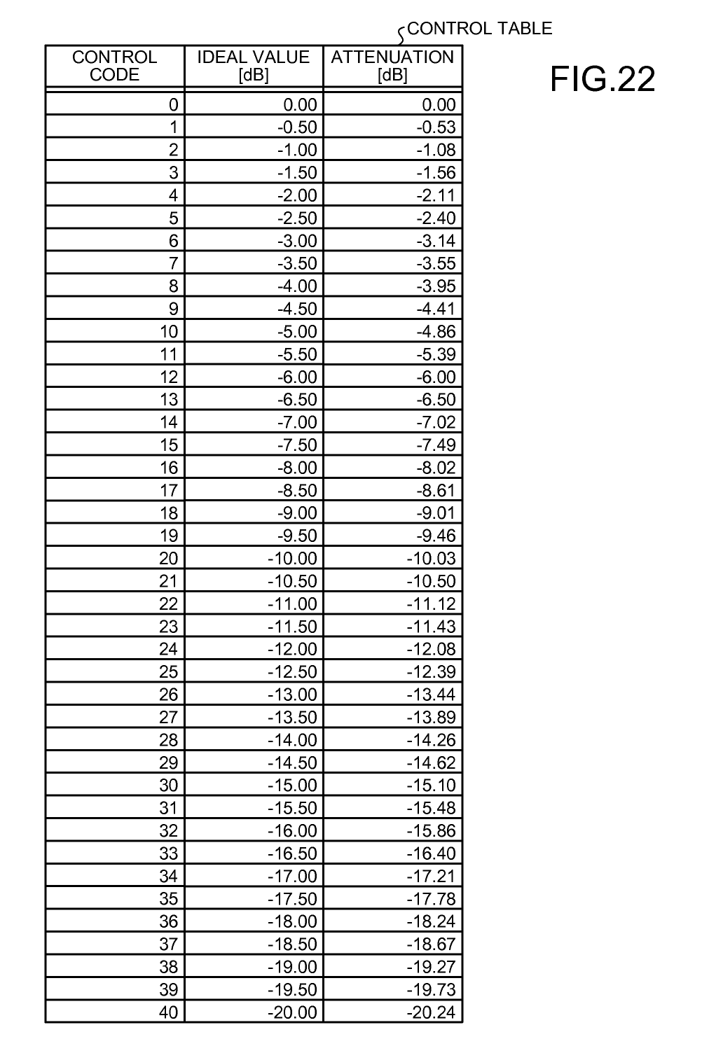

FIG. 22 depicts one example of data structure of the control table according to the first control method. In FIG. 22, an ideal value corresponding to the attenuation is also described. The control table depicted in FIG. 22 is stored in, for example, the DPRAM 260.

The operation unit 270 compares the attenuation stored in the DPRAM 260 and the control table to identify the control code, and outputs the identified control code to the DAC 280. The DAC 280 stores a table indicating the relation between the control code and voltage to be applied on the X-axis/Y-axis. The DAC 280 applies voltage on the X-axis/Y-axis according to the control code acquired from the operation unit 270.

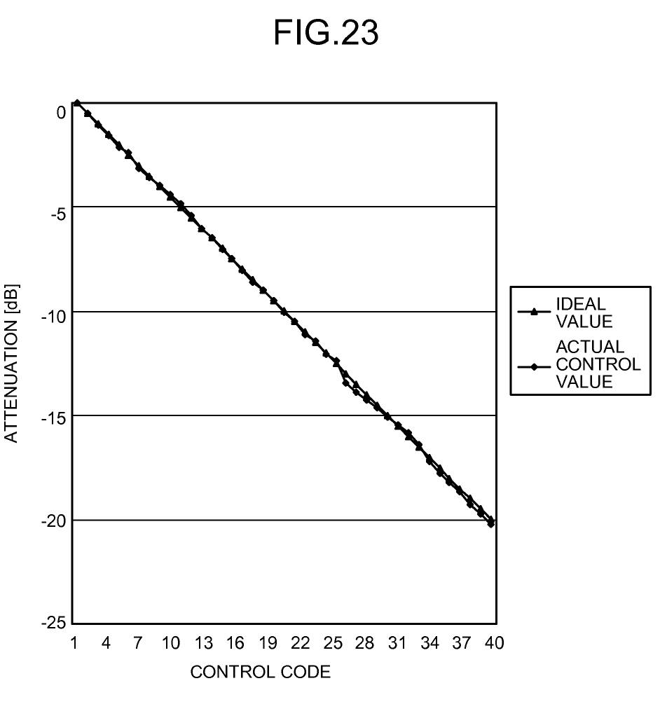

FIG. 23 depicts a relation between an ideal value and the attenuation of each control code according to the first control method. As depicted in FIG. 23, the difference between the actual attenuation and the ideal value corresponding to each control code remains small within a dynamic range, whereby a linear control can be achieved.

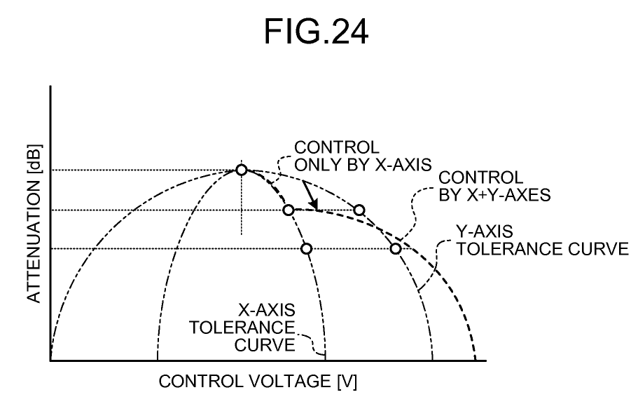

The second control method is explained. FIG. 24 is a graph for explaining the second control method. In the second control method of FIG. 24, the control device 250 applies voltage on the X-axis until a predetermined attenuation (for example, attenuation of a half of target value) is achieved. After achievement of the predetermined attenuation, voltage is applied on the X-axis and the Y-axis to adjust attenuation to a target value.

When V/θ characteristic is larger in the X-axis than in the Y-axis, since adjustment of from a predetermined attenuation to a target value is conducted by application of voltage on the X-axis and the Y-axis, variation in attenuation with respect to voltage is gentle and attenuation can be adjusted to a target value accurately. Unlike the first control method, voltage is applied also on the X-axis from the predetermined attenuation to the target value, and therefore, a linear characteristic can be achieved more dynamically compared with the first control method.

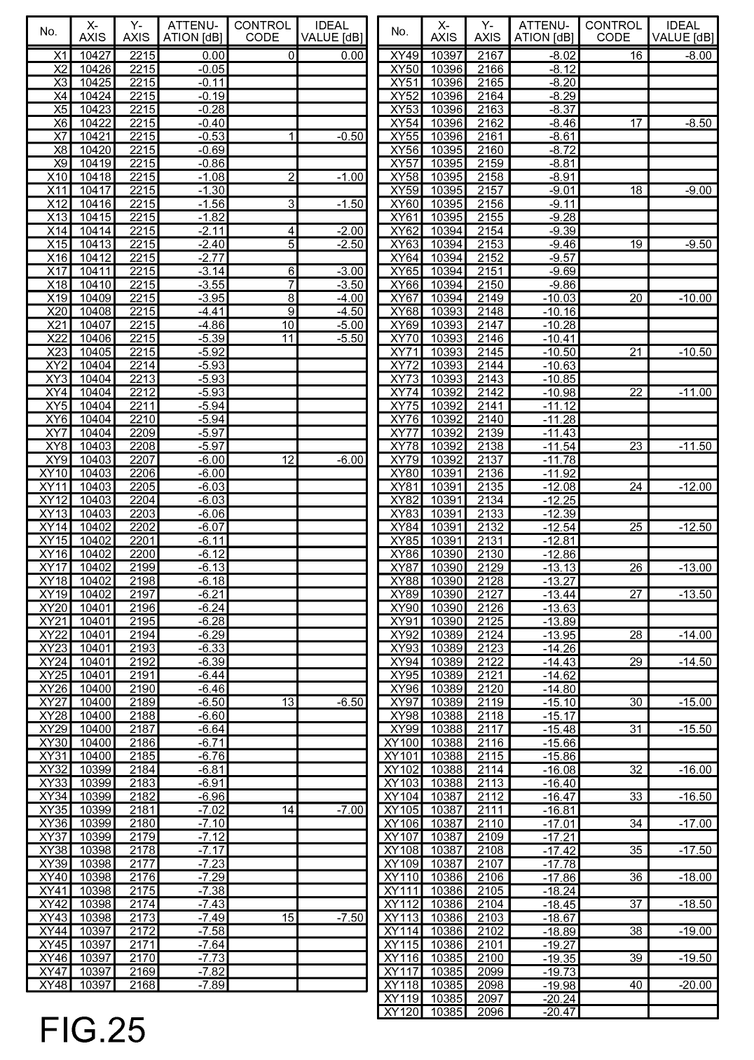

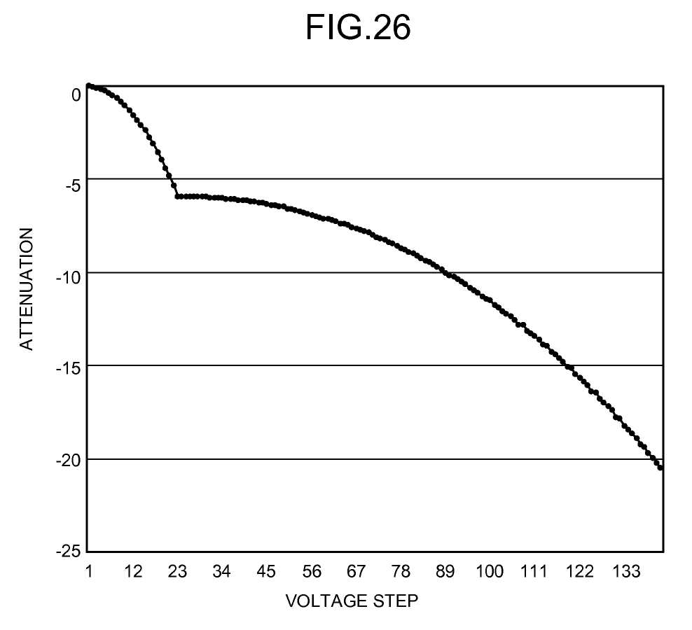

In the second control method, the voltage is first applied on the X-axis until the attenuation reaches a predetermined level, and then the voltage is applied to both the X-axis and the Y-axis. For the simplicity of description, it is assumed that the voltage is applied on the X-axis until the attenuation reaches “−5.92 dB”, and then on both the X-axis and the Y-axis. The variation in attenuation achieved by such X-axis and Y-axis control is explained. FIG. 25 depicts attenuation achieved by the X-axis and Y-axis control according to the second control method, whereas FIG. 26 is a graph of the relation between the attenuation achieved by the X-axis and Y-axis control as depicted in FIG. 25.

When the control device 250 actually controls the attenuation (for example, when controlling the attenuation by every 0.5 dB), the control device 250 extracts approximate data of every 0.5 dB (−0.5 dB, −1.0 dB, −1.5 dB, . . . ) based on the data depicted in FIG. 25. The control device 250 formulates a control table by assigning a control code to each piece of the extracted approximate data.

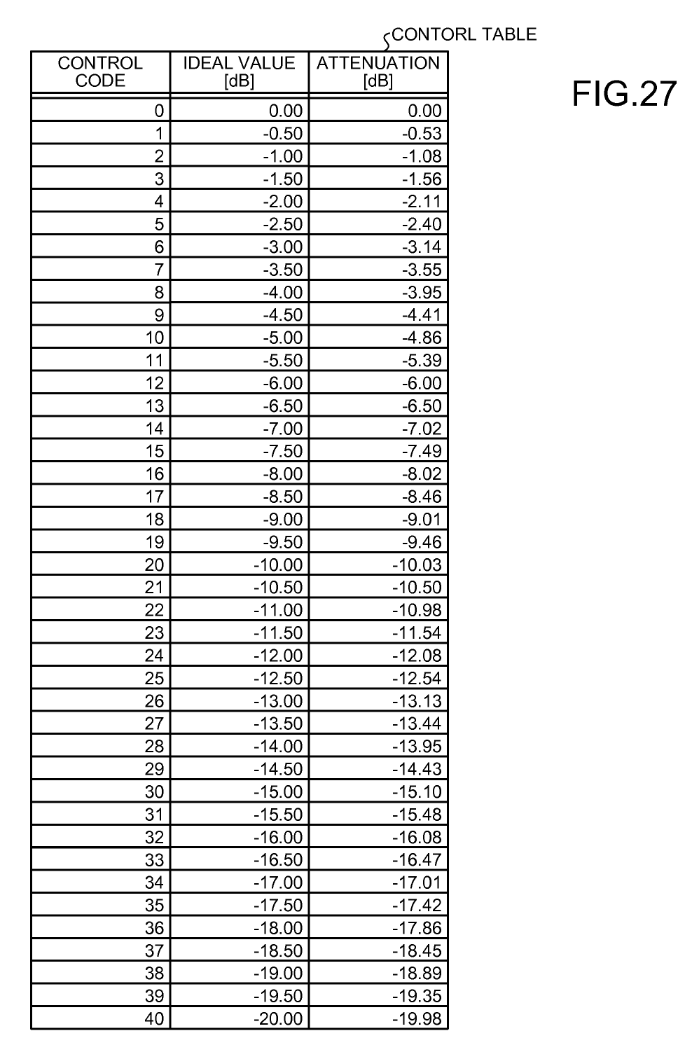

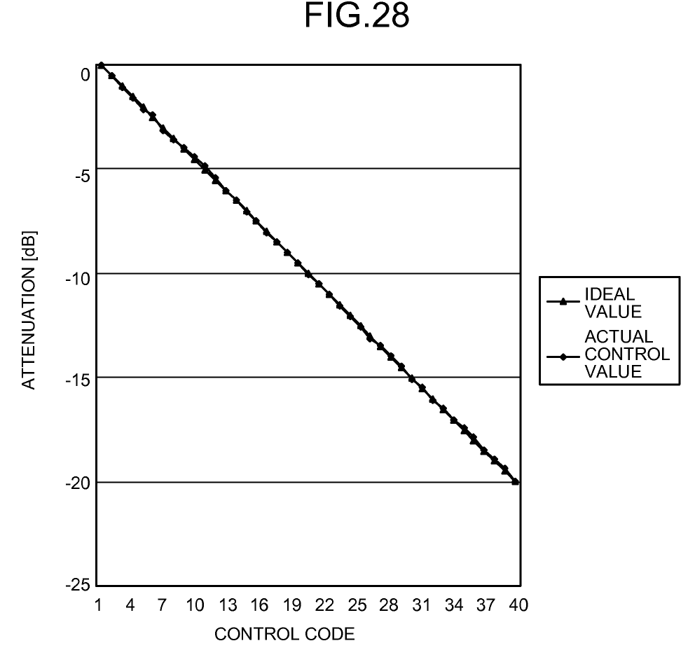

FIG. 27 depicts one example of data structure of the control table according to the second control method. In FIG. 27, an ideal value corresponding to the attenuation is also described. The control table depicted in FIG. 27 is stored in, for example, the DPRAM 260.

The operation unit 270 compares the attenuation stored in the DPRAM 260 and the control table to identify the control code, and outputs the identified control code to the DAC 280. The DAC 280 stores a table indicating the relation between the control code and voltage to be applied on the X-axis/Y-axis. The DAC 280 applies voltage on the X-axis/Y-axis according to the control code acquired from the operation unit 270.

FIG. 28 depicts a relation between an ideal value and the attenuation of each control code according to the second control method. As depicted in FIG. 28, the difference between the actual attenuation and the ideal value corresponding to each control code remains small within a dynamic range, whereby a linear control can be achieved.

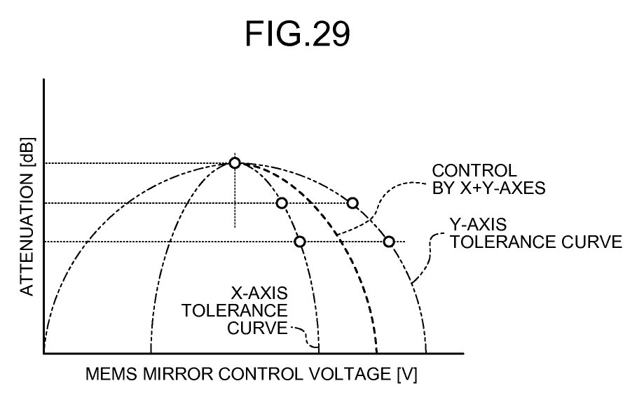

The third control method is explained next. FIG. 29 is a graph for explaining the third control method. In the third control method of FIG. 29, the control device 250 applies voltage on the X-axis and the Y-axis until attenuation reaches a target value. When V/θ characteristic is larger in the X-axis than in the Y-axis, rate of variation in attenuation is smaller than the case where attenuation is adjusted by application of voltage only on the X-axis. Therefore, it is possible to accurately adjust the attenuation to the target value, and further, a linear characteristic can be achieved more dynamically compared with the first and the second control methods.

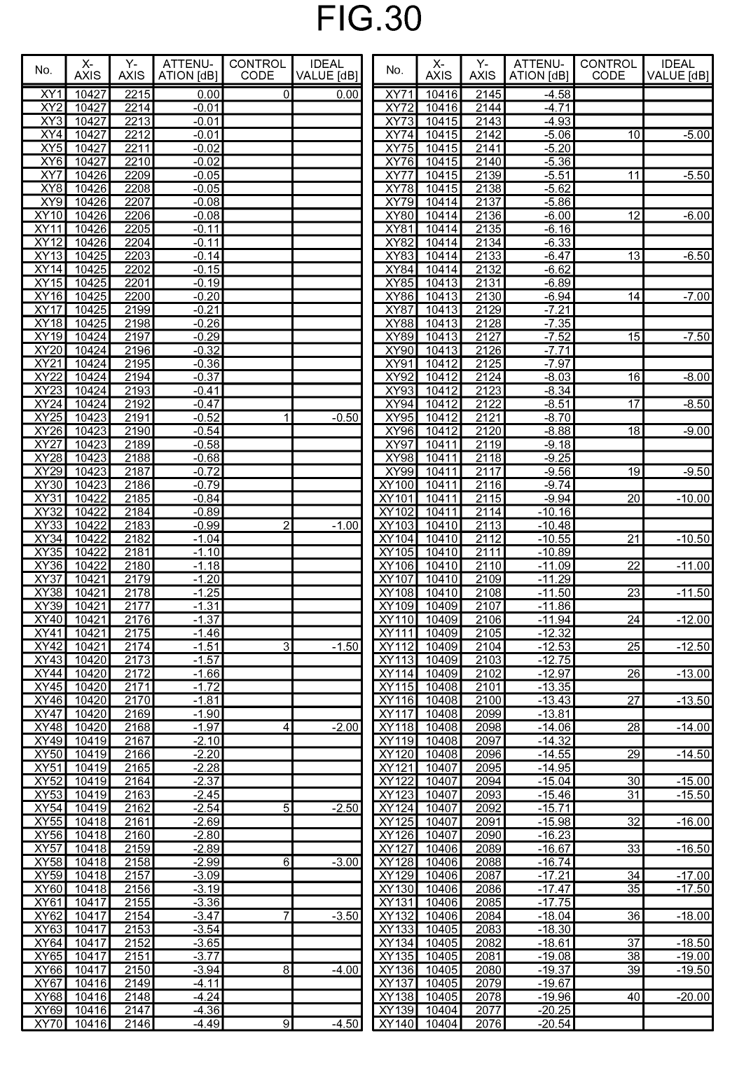

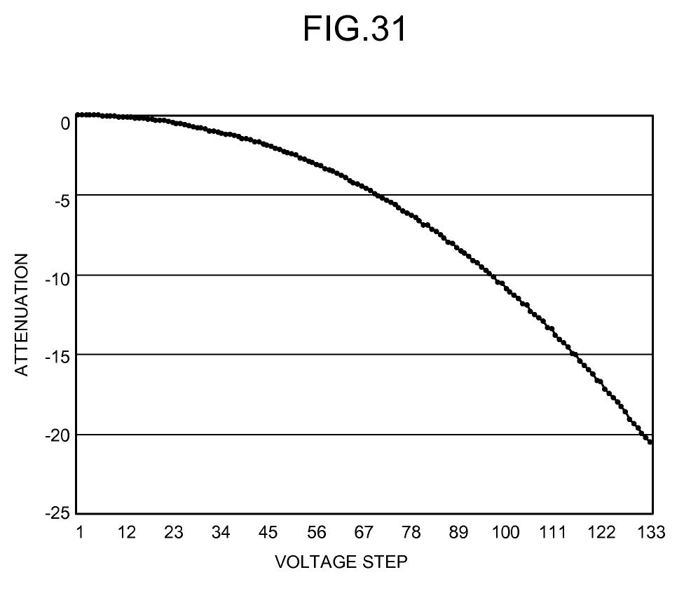

According to the third control method, the voltage is applied on both the X-axis and the Y-axis from the beginning. FIG. 30 depicts attenuation achieved by the X-axis and Y-axis control according to the third control method, and FIG. 31 is a graph representing relation of the attenuation achieved by the X-axis and Y-axis control as depicted in FIG. 30.

When the control device 250 actually controls the attenuation (for example, when controlling the attenuation by every 0.5 dB), the control device 250 extracts approximate data of every 0.5 dB (−0.5 dB, −1.0 dB, −1.5 dB, . . . ) based on the data depicted in FIG. 30. The control device 250 formulates a control table by assigning a control code to each piece of the extracted approximate data.

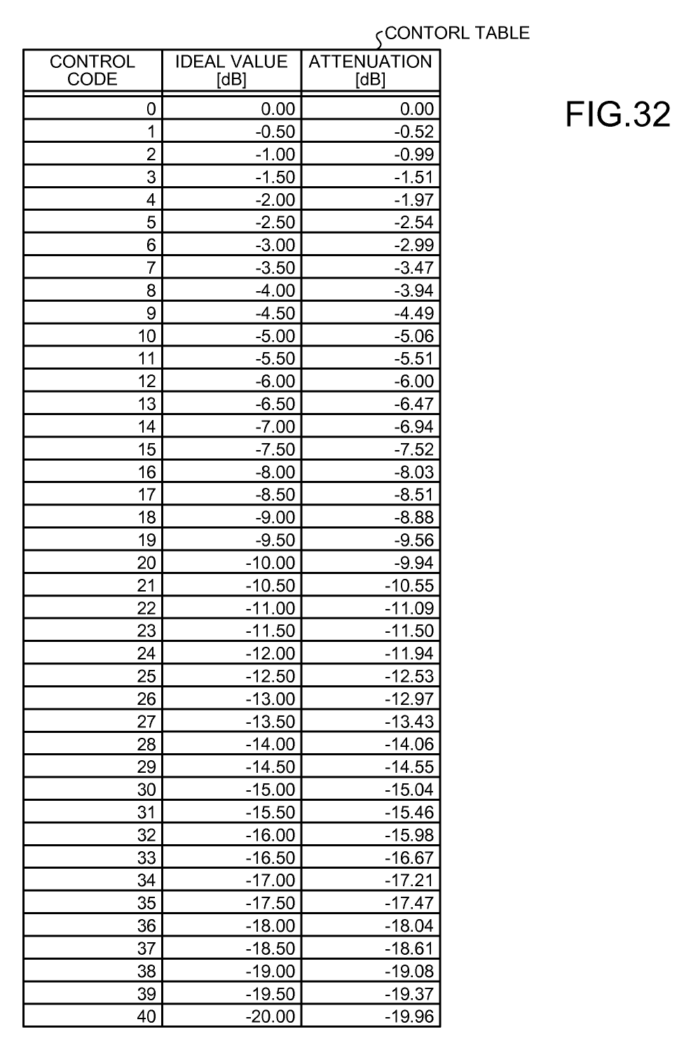

FIG. 32 depicts one example of data structure of the control table according to the third control method. In FIG. 32, an ideal value corresponding to the attenuation is also described. The control table depicted in FIG. 32 is stored in, for example, the DPRAM 260.

The operation unit 270 compares the attenuation stored in the DPRAM 260 and the control table depicted in FIG. 32 to identify the control code, and outputs the identified control code to the DAC 280. The DAC 280 stores a table indicating the relation between the control code and voltage to be applied on the X-axis/Y-axis. The DAC 280 applies voltage on the X-axis/Y-axis according to the control code acquired from the operation unit 270.

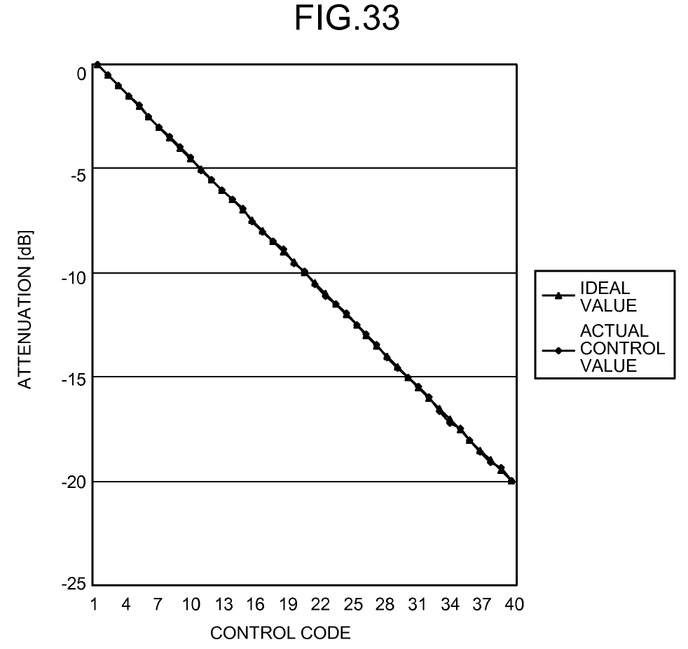

FIG. 33 depicts a relation between an ideal value and the attenuation of each control code according to the third control method. As depicted in FIG. 33, the difference between the actual attenuation and the ideal value corresponding to each control code remains small within a dynamic range, whereby a linear control can be achieved.

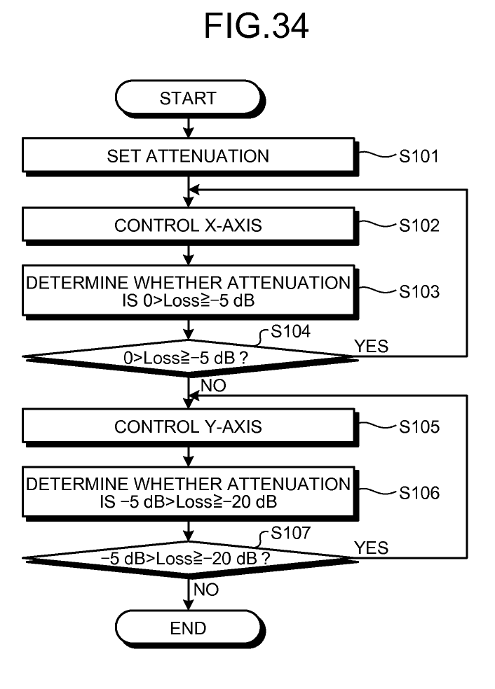

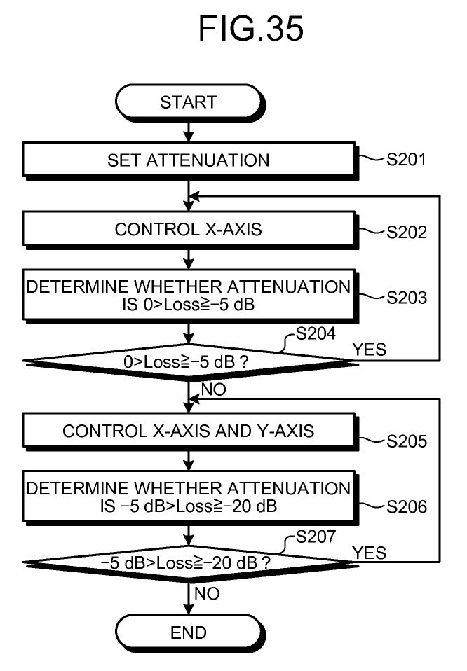

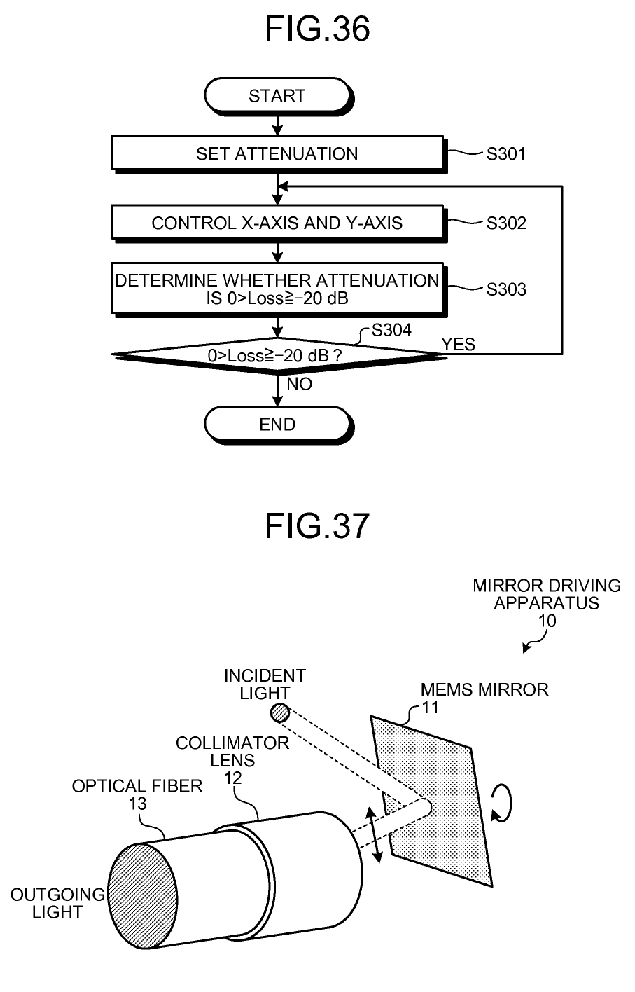

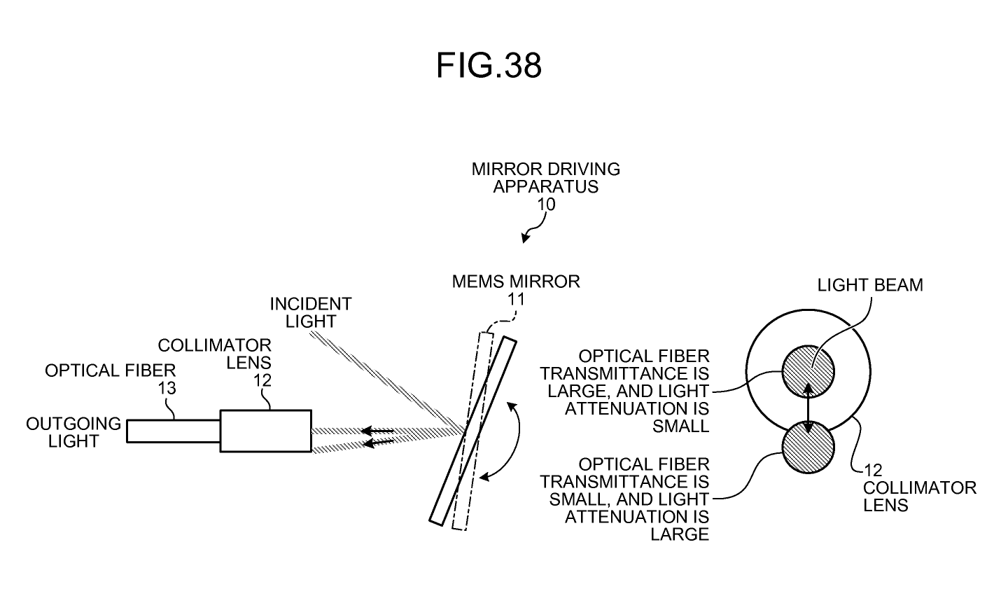

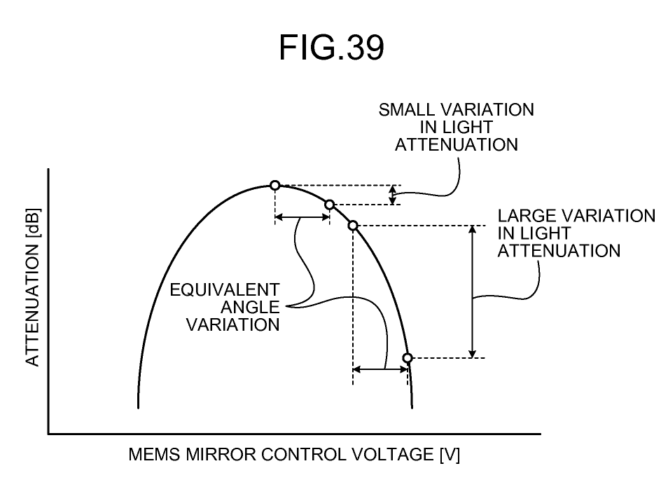

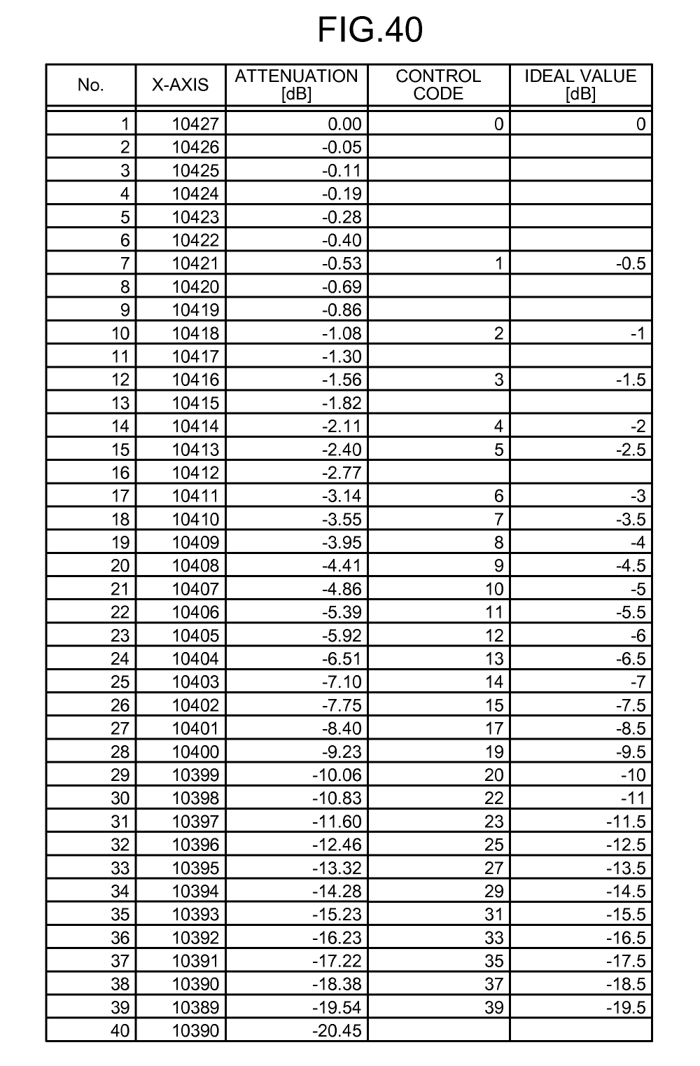

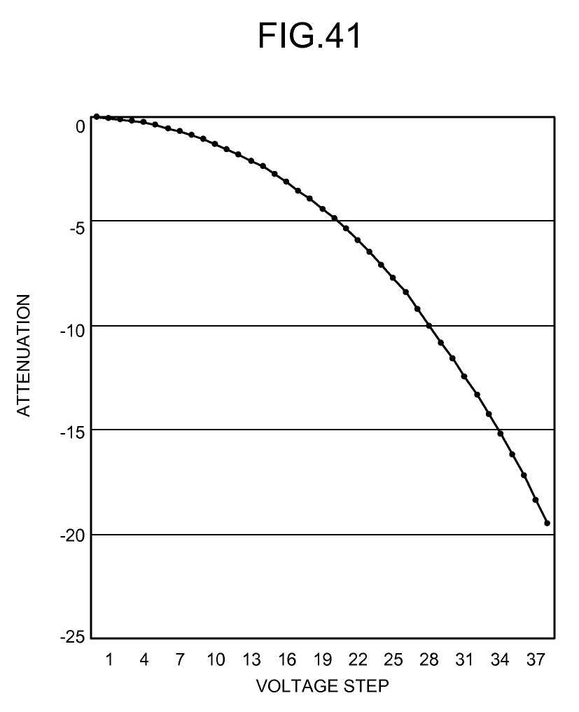

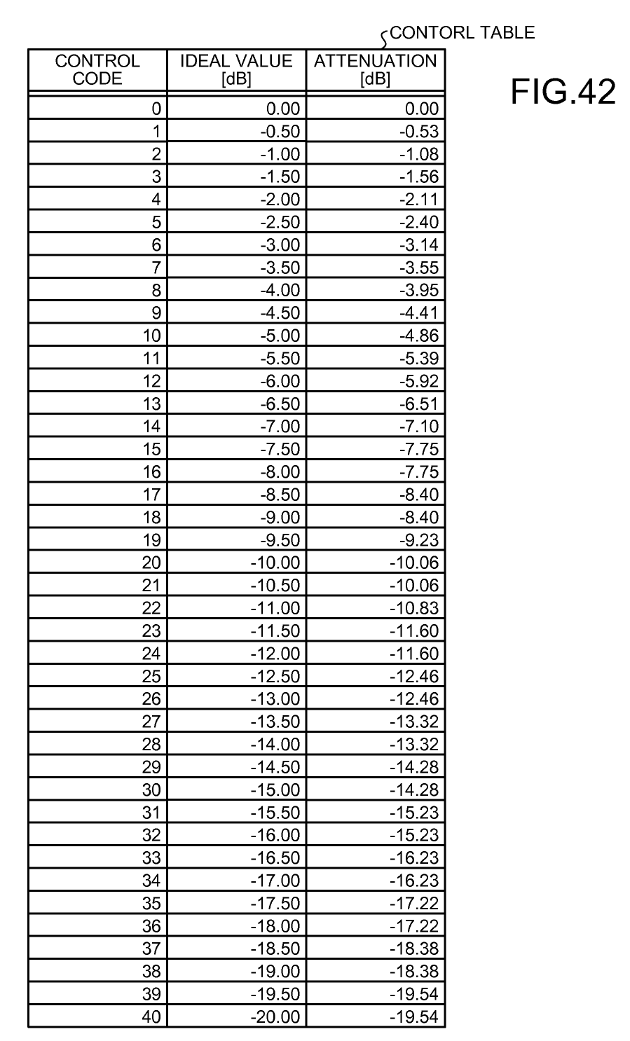

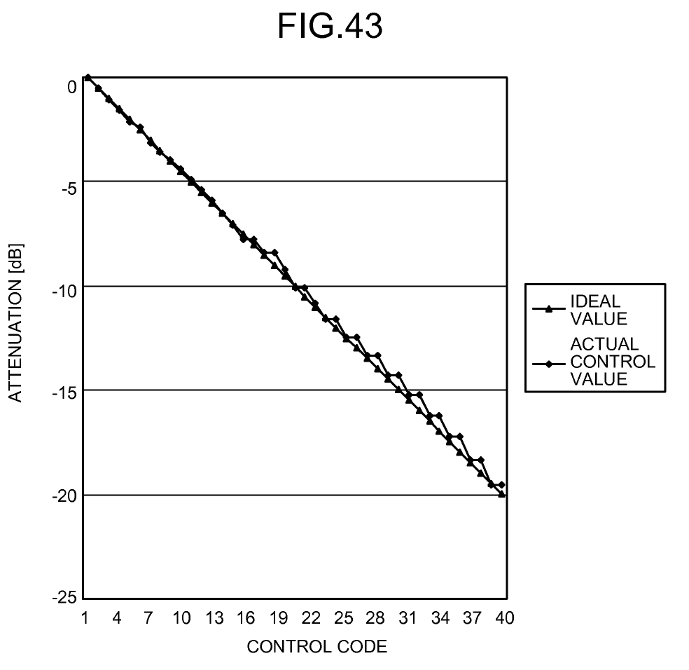

Next, a process sequence of the mirror driving apparatus 200 according to the second embodiment will be explained. FIG. 34 is a flowchart of a process sequence of the mirror driving apparatus 200 that executes the first control method, FIG. 35 is a flowchart of a process sequence of the mirror driving apparatus 200 that executes the second control method, and FIG. 36 is a flowchart of a process sequence of the mirror driving apparatus 200 that executes the third control method. In FIGS. 34 to 36, as one example, attenuation is adjusted to −20 decibels [dB].

As illustrated in FIG. 34, the mirror driving apparatus 200 sets an attenuation (Step S101), controls the X-axis (applies voltage on the X-axis) (Step S102), and determines whether the attenuation (loss) is “0>Loss≧−5 dB” (Step S103).

When the attenuation is “0>Loss≧−5 dB” (Yes at Step S104), the procedure proceeds to Step S102. On the other hand, when the attenuation is not “0>Loss≧−5 dB” (No at Step S104), the mirror driving apparatus 200 controls the Y-axis (applies voltage on the Y-axis) (Step S105), and determines whether the attenuation is “−5 dB>Loss≧−20 dB” (Step S106).

When the attenuation is “−5 dB>Loss≧−20 dB” (Yes at Step S107), the procedure proceeds to Step S105. On the other hand, when the attenuation is not “−5 dB>Loss≧−20 dB” (No at Step S107), the process ends.

As illustrated in FIG. 35, the mirror driving apparatus 200 sets an attenuation (Step S201), controls the X-axis (applies voltage on the X-axis) (Step S202), and determines whether the attenuation is “0>Loss≧−5 dB” (Step S203).

When the attenuation is “0>Loss≧−5 dB” (Yes at Step S204), the procedure proceeds to Step S202. On the other hand, when the attenuation is not “0>Loss≧−5 dB” (No at Step S204), the mirror driving apparatus 200 controls the X-axis and the Y-axis (applies voltage on the X-axis and the Y-axis) (Step S205), and determines whether the attenuation is “−5 dB>Loss≧−20 dB” (Step S206).

When the attenuation is “−5 dB>Loss≧−20 dB” (Step S207, Yes), the procedure proceeds to Step S205. On the other hand, when the attenuation is not “−5 dB>Loss≧−20 dB” (Step S207, No), the process ends.

Next, as illustrated in FIG. 36, the mirror driving apparatus 200 sets an attenuation (Step S301), controls the X-axis and the Y-axis (applies voltage on the X-axis and the Y-axis) (Step S302), and determines whether the attenuation is “0>Loss≧−20 dB” (Step S303).

When the attenuation is “0>Loss≧−20 dB” (Step S304, Yes), the procedure proceeds to Step S302. On the other hand, when the attenuation is not “0>Loss≧−20 dB” (Step S304, No), the process ends.

The mirror driving apparatus 200 may adjust the attenuation by using any of the first to the third control methods of FIGS. 34 to 36. Alternatively, it may appropriately switch the control method according to the attenuation.

As described above, since the mirror driving apparatus 200 according to the second embodiment forms the MEMS mirror of two axes (for example, X-axis, Y-axis) having different V/θ characteristics (rate of variation in voltage (attenuation) with respect to angle), and controls the angle of mirror by combination of the X-axis and the Y-axis to adjust attenuation of light. Therefore, it is possible to control the light attenuation characteristic by a more uniform voltage step, and to accurately adjust the attenuation.

A process explained herein as being automatically executed, among the processes explained in the embodiments of the present invention may be entirely or partly executed manually, or a process explained herein as being manually executed may be entirely or partly executed automatically by a known method. Besides the above, the process sequence, control sequence, concrete name, information including various data and parameters discussed in this context and depicted in the drawings may be arbitrarily modified unless otherwise specified.

Each constituent like the mirror driving apparatus 200, and the control device 250 as described above is disclosed as functional concept, and is not necessarily configured physically as illustrated in the drawings. In other words, concrete forms of dispersion and integration of each apparatus are not limited to those illustrated in the drawings, and all or part thereof may be functionally or physically dispersed or integrated by arbitrary units depending on a variety of loads or use circumstances.

The configuration of the MEMS mirror (MEMS actuator) depicted in FIG. 16 may be made the same as that of the MEMS actuator 100 according to the first embodiment. More specifically, the fixed electrode and the movable electrode of the MEMS mirror 210 may be formed so that the distance between the fixed electrode and the movable electrode widens as the overlapping area between the fixed electrode and the movable electrode increases. Further, the attenuation is adjusted through the control of the angle of the MEMS mirror achieved through a combination of axes with different V/θ characteristics. Thus, the error in attenuation can be eliminated, and the light-attenuation characteristic can be controlled through even more constant voltage step.

According to the electrodes of the embodiments, it is possible to keep electrostatic force substantially constant owing to characteristics of an electrostatic actuator, and to keep a rate of variation in attenuation with respect to voltage constant irrespective of a magnitude of applied voltage (in other words, relationship between voltage and mirror angle has a linear characteristic). Therefore, it is possible to control attenuation accurately.

According to the mirror driving apparatus of the embodiments, since attenuation is adjusted by controlling an angle of a MEMS mirror by combining axes having different V/θ characteristics, it is possible to control a light attenuation characteristic by a more uniform voltage step.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An electrode comprising:
a fixed electrode; and
a movable electrode,
the electrode driving a mirror disposed on the side of the movable electrode by generating electrostatic force between the fixed electrode and the movable electrode when voltage is applied,
the fixed electrode and the movable electrode being formed so that a distance between the fixed electrode and the movable electrode increases as an overlapping area between the fixed electrode and the movable electrode increases.

2. The electrode according to claim 1, wherein the fixed electrode and the movable electrode have a comb-like shape.

3. A mirror driving apparatus comprising:
a mirror that has a first axis and a second axis, and whose angle is controlled through application of voltage on at least one of the first axis and the second axis, a rate of variation in attenuation with respect to a rotation angle of the mirror around the first axis and a rate of variation in attenuation with respect to the rotation angle of the mirror around the second axis being different from each other; and
an attenuation adjusting unit that adjusts attenuation of light by applying voltage on at least one of the first axis and the second axis to control an angle of the mirror and to adjust a position where light is applied.

4. The mirror driving apparatus according to claim 3, wherein the attenuation adjusting unit applies voltage on the second axis to adjust attenuation of light after adjusting attenuation of light by applying voltage on the first axis.

5. The mirror driving apparatus according to claim 3, wherein the attenuation adjusting unit applies voltage on the first axis and the second axis to adjust attenuation of light after adjusting attenuation of light by applying voltage on the first axis.

6. The mirror driving apparatus according to claim 3, wherein the attenuation adjusting unit adjusts attenuation of light by simultaneously applying voltage on the first axis and the second axis.

7. A mirror driving apparatus comprising:
an electrode including a fixed electrode and a movable electrode, the electrode being configured to drive a mirror disposed on the side of the movable electrode by generating electrostatic force between the fixed electrode and the movable electrode when voltage is applied on at least one of a first axis and a second axis, and a distance between the fixed electrode and the movable electrode widens as an area where the fixed electrode and the movable electrode overlap with each other increases; and
an attenuation adjusting unit that adjusts attenuation of light by applying voltage on at least one of the first axis and the second axis, wherein
the electrode being configured to change the attenuation by a different rate of variation when the voltage is applied on the first axis from when the voltage is applied on the second axis.
